(19) United States
(12) Patent Application Publication
(10) Pub. No.: US 2006/0239801 A1
(43) Pub. Date: Oct. 26, 2006

(54) System for dynamically preparing and commissioning especially pallets and other storage units

(75) Inventors: Timm Gudehus, Hamburg (DE); Gunther Lukas, Wartenberg (DE)

Correspondence Address: BANNER & WITCOFF, 1001 G STREET N W, SUITE 1100, WASHINGTON, DC, 20001, US

(73) Assignee: KRUSCHE, LAGERTECHNIK AG, Erding (DE)

(21) Appl. No.: 10/533,423

(22) PCT Filed: Nov. 3, 2003
(86) PCT No.: PCT/EP03/12257

§ 371 Date: Apr. 10, 2006

(30) Foreign Application Priority Data
Nov. 1, 2002 (DE) 102 50 964.6

(51) Int. Cl. B65G 1/00

(52) U.S. Cl. 414/277

(57) ABSTRACT

A system for the dynamical providing of storing units with goods contained therein consists at least of: a storage area consisting of at least one rack module composed of at least two rack plates separated from each other by an alley, for storing the storing units in rack shelves; a floor-bound transport system with at least one vehicle; a store feeding system working floor-free and comprising at least one storing device that is designed and suited to take storing units with goods out of the rack shelves and to transport same above a driving track of said at least one vehicle in hanging to at least one commissioning shelf for the floor-bound transport system and, as the case may be, to transport other storing units back from this commissioning shelf; a control system that is designed such that it collects at least the occupancy data of the storing places and the movement and/or position data of the floor-bound vehicles and of the floor-free storing devices and that, by using this information, coordinates and controls the substantial functions of placing in storage and/or returning to storage, storing and/or intermediately buffering, removing from storage and/or providing of the entire system.

The invention relates to a system for the dynamical providing of storing units with goods contained therein.

In order to enable a substantially dynamical providing with usual commissioning systems, floor-bound rack feeding devices are conventionally used for the storing and transferring of storing units, said floor-bound rack feeding devices being combined with a substantially stationary conveying system. The stationary conveying system is adapted to the respective requirements, for instance the type of good to be transported or the project demands, so that different conveying measures can be undertaken. The stationary conveying system may, for example, consist of roller conveyors, chain conveyors, direction change devices, or rail-bound distribution carriages.

Since the efficiency of a commissioning system is substantially determined by the transport breakeven performance of the individual system components, the usual commissioning systems, consisting of floor-bound, firmly installed rack feeding devices and stationary conveying systems, are restricted in their performance. In this respect, they suffer substantial drawbacks with regard to flexibility when there are fluctuations in the utilization efficiency, for instance in seasonal peak times (e.g. Christmas business in the mail-order field), or in the case of failure of the individual system components due to maintenance or repair.

It is therefore an object of the present invention to provide a system enabling a highly dynamical providing of storing units with goods contained therein, so that goods are transported from a storage area to a particular providing station at optimal time and path, and wherein the system further comprises a high degree of flexibility with respect to fluctuations of the utilization efficiency and the range of articles.

This object is solved by the inventive system for the dynamical providing of storing units with goods contained therein with the features according to claim 1, and with the inventive system for the dynamical providing of storing units with goods contained therein with the features according to claim 3. Advantageous further developments of the invention are characterized in subclaims 4 to 16.

The inventive system for the dynamical providing of storing units with goods contained therein consists at least of
a storage area consisting of at least one rack module composed of at least two rack plates separated from each other by an alley, for storing the storing units in rack shelves;
a floor-bound transport system with at least one vehicle that is designed and suited to take storing units out of the rack shelves and to transport same to at least one providing station inside or outside the storage area;
a store feeding system working floor-free and comprising at least one storing device that is designed and suited to take storing units with goods out of the rack shelves and to transport same above a driving track of said at least one vehicle in hanging to at least one commissioning shelf for the floor-bound transport system and, as the case may be, to transport other storing units back from this commissioning shelf;
a control system that is designed such that it collects at least the occupancy data of the storing places and the movement and/or position data of the floor-bound vehicles and of the floor-free storing devices and that, by using this information, coordinates and controls the substantial functions of placing in storage and/or returning in storage, storing and/or intermediately buffering, removing from storage and/or providing of the entire system.

In another preferred embodiment of the inventive system for the dynamical providing of storing units with goods contained therein, the system consists at least of
a storage area with rack plates separated from one another by at least one alley, comprising rack shelves for storing the storing units in the rack shelves;
a floor-bound transport system with at least one vehicle that is designed and suited to take storing units out of the rack shelves and to transport same through the at least one alley to at least one first area inside or outside the storage area;
a store feeding system working floor-free with at least one traversing unit with load receiving means which is designed and suited to take storing units with goods out of the rack shelves and to transport same above a driving track of the at least one vehicle in hanging to a second area;
at least one operating unit that is designed to collect at least substantial state data of the at lest one vehicle and the at least one traversing unit with load receiving means, so that collisions of the at least one vehicle and the at least one traversing unit with load receiving means are avoided.

Expediently, the at least one vehicle is designed as a driverless transport vehicle and is suited to transport at least one storing unit.

Expediently, the at least one driverless transport vehicle may consist of an association of several transport units that are coupled with one another, for instance, via mechanical means or via non-mechanical means, e.g. opto-electronic signals.

The at least one driverless vehicle advantageously comprises lifting means for lifting and lowering the storing units.

In accordance with the invention, the at least one traversing unit with load receiving means is positioned in the at least one alley.

The inventive system for the dynamical providing of storing units with goods contained therein thus consists substantially of four partial systems, wherein the operating unit that is designed as control system performs the coordination and adjustment of the individual partial systems with respect to each other.

In addition to the inventive partial systems
storage area with racks;
floor-bound transport system, for instance DTS system;
floor-free store feeding device, for instance TransFaster® technology, a substantially stationary conveying technology will regularly form the periphery of the system according to the invention, wherein the conveying technology is suited to perform the input, output, commissioning, and providing of the individual goods.

A possible output consists, for instance, in performing an assembly of individual parts, or to combine a plurality of different articles. It is, for instance, possible with the system according to the invention to commission, at optimal time, a plurality of different article units that are each arranged in a major number of units on individual pallets. Another advantage of the system according to the invention consists in the possibility of yielding high performance as well as high flexibility with respect to the arrangement of the individual system components. It is of further advantage that both the entire system and the individual components can be scaled pursuant to the changing customer demands.

1. Storage Area

The storage area necessary for the system according to the invention consists expediently of at least one rack module consisting of at least two rack plates with individual rack shelves, said rack plates being separated from each other by an alley and being substantially parallel to each other, and said rack shelves being dimensioned pursuant to need.

Possible storing units are, for instance, pallets, mesh box pallets, containers, long good cassettes, trays, or system pallets in which different goods can be stored. For increasing flexibility, it is possible to provide a combination of the different storing units in a storage area.

The dimensioning of the storage area, for instance, rack length, number of alleys, rack height and rack depth, depends e.g. on the respectively required storage capacities, the number of articles, the dimension of articles, the providing dynamics required, and/or the respective weight of the articles or storing units, respectively.

In order to achieve a particularly efficient utilization of the storage area, it may be useful to perform a multiple deep storage successively, wherein a combination of a storage of simple depth with storages of multiple depth is also possible.

To achieve an inventive providing of storing units with goods contained therein at optimal time and path, it is advantageous to classify the goods in different categories of priority pursuant to the frequency of access, and to perform a placing in storage in the storage area pursuant to this categorization.

While particularly popular articles that are accessed very frequently may, for instance, be referred to as A-articles, articles that are accessed less frequently may be referred to as B-articles, and articles that are accessed very rarely may be referred to as C-articles. In accordance with this categorization, it is of advantage to place the so-called A-articles in storage in those lower rack levels that can be accessed directly by means of a floor-bound transport system, e.g. a DTS.

With a DTS with lifting means which is designed such that a lifting of the storing units arranged thereon may be performed up to the third rack level, it is advantageous to place the A-articles permanently in storage in the first three lower rack levels. The remaining rack shelves of the lower rack levels can be used dynamically for temporarily providing the access units of the B- or C-articles.

Above those rack levels that can be attended to directly by the DTS, storing units with A-, B- and C-articles are expediently stored and are transferred only on demand, i.e. on signal of the operating unit that is designed as control system, by the store feeding device working floor-free, for instance a TransFaster®, i.e. are transported from the storing levels that are not accessible by means of a DTS to storing levels that are accessible by a DTS.

Apart from this coarse classification of DTS accessible and not DTS accessible storing levels, it is further possible to perform a classification within the DTS accessible rack levels, wherein a hierarchical differentiation pursuant to the frequency of access is possible.

In the case of a DTS with lifting means which is designed to be adapted to attend to the lower three rack levels, the A-articles would nevertheless be stored preferably in the lower-most rack level since the access time in this rack level is shorter than the access time in the rack level thereabove since at least one vertical movement of the lifting means has to take place after the traveling movement of the DTS.

When choosing the rack shelves for A-articles, it may be advantageous in accordance with the invention to provide same in the lowermost rack level each close to the center of a rack section, so that the placing in storage, removing from storage and transferring by the store feeding device working floor-free, for instance a TransFaster®, is optimal with respect to time and path. It may also be advantageous to distribute a plurality of commissioning places over a rack section.

2. Floor-Bound Transport System

The system according to the invention makes use of a floor-bound transport system with at least one vehicle that is designed and suited to take storing units out of the rack shelves and to transport same through the at least one alley to at least one first area inside or outside the storage area and, as the case may be, also back again.

The floor-bound transport system that may, for instance, be designed as a driverless transport system (DTS), takes over the transport of the storing units, wherein a control of the individual vehicles may be performed by means of different systems that are, however, known to a person skilled in the art.

The DTS track network is advantageously formed such that the driving tracks do not only extend along the rack alleys, but that also the rack plates and alleys are crossed preferably perpendicularly and that individual blocks are thus generated in the storage area, said blocks being dimensioned such that, in the case of the inventive combination of the floor-bound transport systems with store feeding systems working floor-free, a providing of storing units with goods contained therein may be performed at optimal time and path.

With the inventive system for the providing of storing units with goods contained therein, the following advantages may be achieved inter alia:
The floor-bound transport systems, for instance the DTS vehicles, are capable of placing in storage and/or removing from storage, and providing access units of the category A-articles provided in the lower rack levels with little expenditure of time and also cost.
The store feeding devices working floor-free, for instance TransFaster®, are capable of transferring the supplies from the rack levels stored above the accessibility of the DTS to the range of action of the DTS vehicles, so that the storing units available there are also directly accessible for the DTS vehicles and may be taken out for providing.
The TransFasters® take over substantially only the supplies of the A-articles and the providing of the B- and C-articles.

Advantageously the DTS is, if it is equipped with a lifting means, provided with means that are designed and arranged such that a reliable supporting of the DTS in the alley is performed with a maximum lifting performance so as to ensure a safe removing from storage and placing in storage in the corresponding rack shelves during the horizontal movement of the storing unit with goods contained therein. A horizontal transport means may, for example, be realized by means of telescope forks that are arranged on or integrated in a lifting platform that is positioned on the load receiving means.

3. Store Feeding System Working Floor-Free

The store feeding system that works floor free with at least one storing device consisting preferably of a traversing unit with load receiving means is designed such that it is adapted to take storing units with goods out of the rack shelves and to transport same above a driving track of the at least one vehicle in hanging to a second area.

To this end, the traversing unit runs on at least one of rail-like guiding means that are arranged in the alleys between the rack plates preferably on one of the upper shelf levels at the rack construction. The load receiving means is expediently connected by means of a connecting means, for instance via rope elements, with the traversing unit, wherein a corresponding rope winch system is arranged at the traversing means that is horizontally movable on the rail-like guiding means so as to cause a vertical movement of the load receiving means vis-à-vis the traversing unit pursuant to need.

The traversing unit with load receiving means is designed such that a vertical movement of the load receiving means is possible via the winch system during a horizontal movement of the traversing unit.

The load receiving means is designed such that storing units can be positioned standing thereon or hanging therebelow. The load receiving means further comprises means for transporting a storing unit transported therewith horizontally in a rack shelf, or for removing it from storage, respectively. Such a horizontal transport means may, for instance, be realized by means of telescope forks that are arranged on or integrated in a lifting platform that is positioned on the load receiving means.

If a storing unit is arranged to hang below the load receiving means, a device for a horizontal movement with an appropriate lifting means is also necessary to perform a horizontal movement to a corresponding rack shelf or from a rack shelf, respectively.

Corresponding to the fixing means at the lifting means of the floor-bound transport system, the load receiving means expediently comprises a fixing means that comprises mechanical means for the positive or non-positive connection of the load receiving means with the two adjacent rack plates.

In order to be able to perform a transport of storing units with goods contained therein with the store feeding device working floor-free, for example a TransFaster®, at optimal time, it is advantageous to guarantee a substantially pendulum-free transport of the storing units. To this end, every store feeding device working floor-free is equipped with an appropriate system control that enables the load receiving means with storing unit with goods contained therein to be transported by means of a specific track control on a path between the providing places and the rack shelves at optimal time.

Advantageously, the individual store feeding devices working floor-free, for instance TransFasters®, may be arranged on different levels or on one level, and may thus increase the providing or flexibility within an alley substantially.

In a further preferred embodiment of the system according to the invention, an alley changing means is used to be able to employ a store feeding device working floor-free in several alleys. This may, for instance, be necessary when, in a particular storage area, storing units with goods contained therein are stored which have to be accessed very rarely only, or in storage areas which do not have to yield a particular providing efficiency.

With the use of an alley changing means, for instance, the TransFaster®is changed from one alley to another, parallel alley, so that the utilization degree for the store feeding device working floor-free can be substantially increased.

By the combination of the different flexibility measures such as alley changing means, modification of the load receiving means for several storing units, use of several TransFasters® in one alley, an adaptation to different total efficiencies can be performed even after the providing of the system according to the invention.

4. Operating Unit

The operating unit of the inventive system which is designed as system control is advantageously constructed hierarchically in a decentralized manner. To this end, the individual functions of the system elements on the process control level are controlled by individual and group controls of the floor-bound transport system, the store feeding system working floor-free, and, as the case may be, of the stationary conveying technology.

Such individual functions may, for instance, be the traveling speed of the DTS vehicles or the collision prevention of individual DTS vehicles. One individual function that is essential for the TransFaster® is, for example, the pendulum suppression during the horizontal transport of the traversing unit.

The functions of the system elements and of the partial systems are initiated, coordinated and controlled by a store administration and operating control system. In a particularly preferred embodiment of the system according to the invention, a store administration and operating control system may receive orders form a higher business administration system, for instance an SAP R/3 and, as the case may be, also report back the execution of individual orders.

The store administration and operating control system may take over the following tasks and functions:
order disposition
storage place administration
DTS system control
conveying technology coordination
working place control
performance recording.

A preferred embodiment of the system according to the invention will be explained in more detail by means of the enclosed drawings. There shows:

FIG. 1 a lateral sectional representation of a storage area of the system according to the invention;

FIG. 2 a sectional representation of the storage area pursuant to FIG. 1;

FIG. 3 a detailed view of a storage area of the system according to the invention with a line of vision along a rack alley;

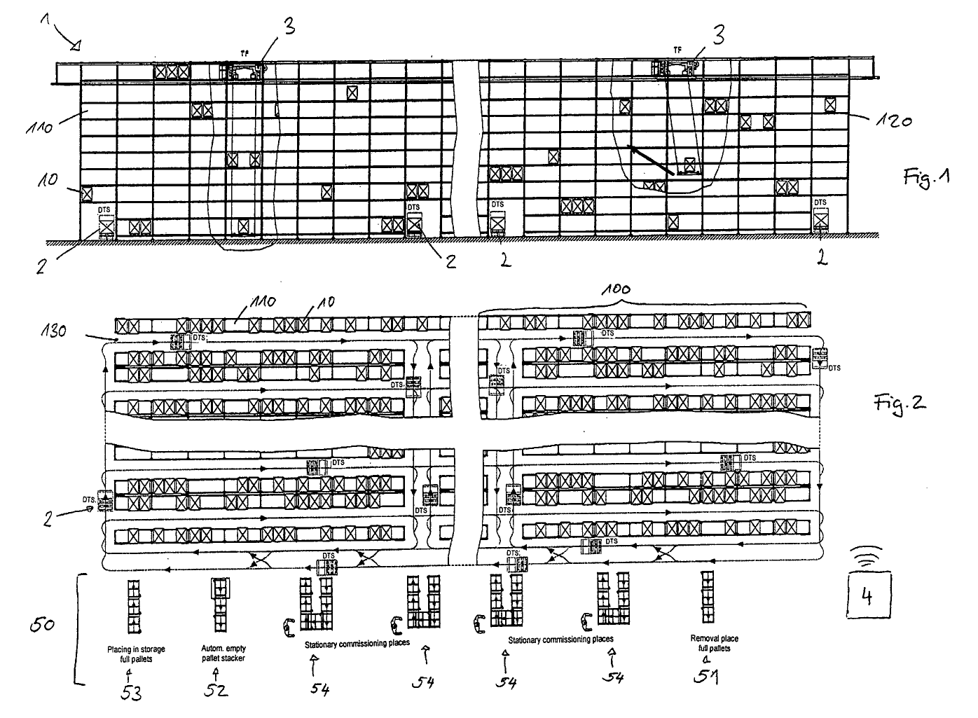

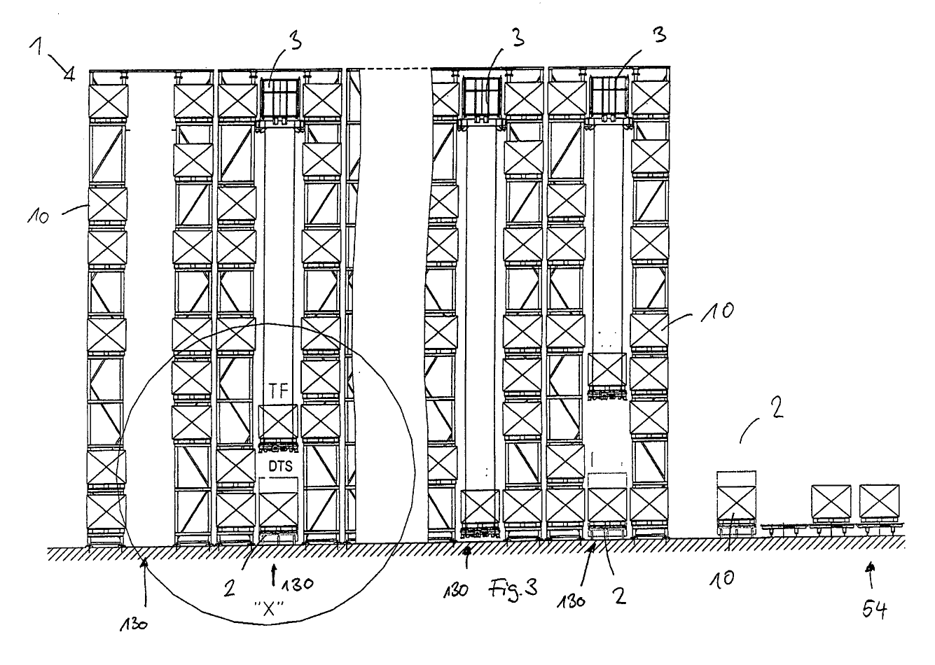

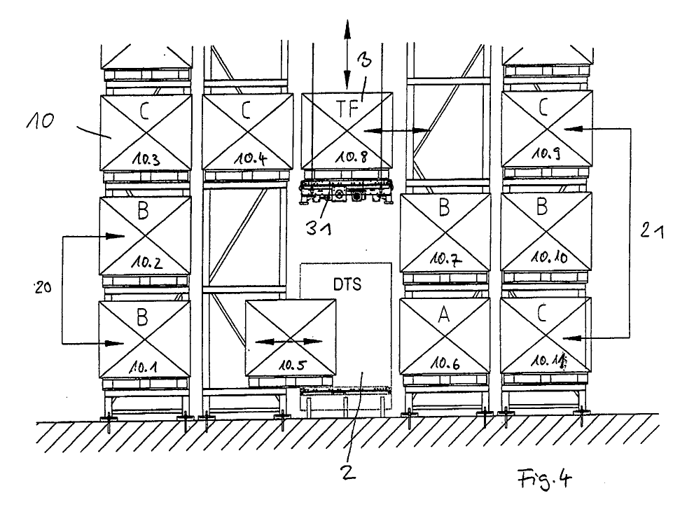

FIG. 4 a schematic representation of the placing in storage, transferring and removing from storage of storing units;

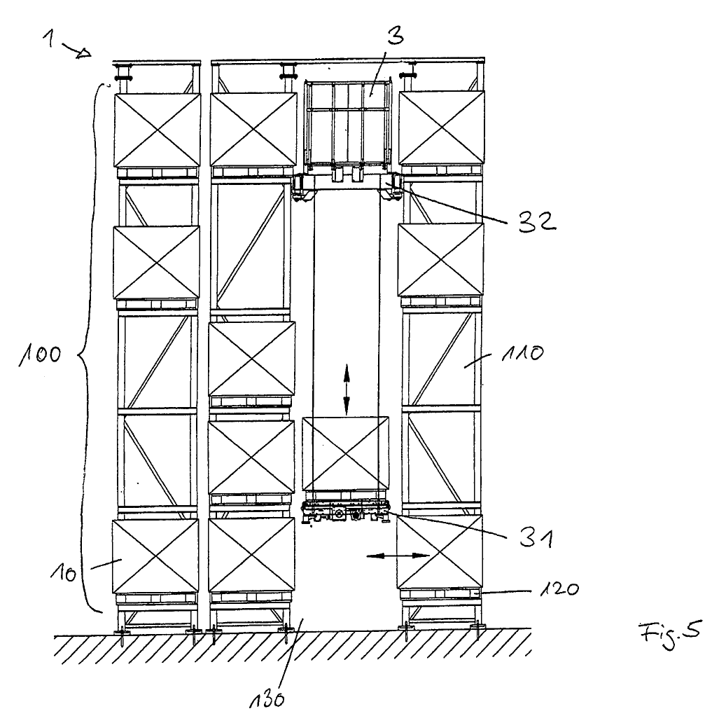

FIG. 5 a schematic representation of a section of the storage area of the system according to the invention;

FIG. 6 a top and lateral view of a DTS with a storing unit positioned thereon.

FIG. 1 shows a lateral view of a storage area 1 of a system according to the invention with four driverless transport vehicles, DTS 2, that are arranged to drive on the floor of the storage area 1 on appropriate tracks. In the storage area 1, a plurality of storing units 120 with goods 10 contained therein are arranged, and two store feeding devices 3 working floor-free are provided, which are designed such that all storing units 120 in the rack shelves 110 can be attended to.

FIG. 2 shows a top view of the storage area 1 that is formed of a plurality of rack plates 100 that are arranged substantially parallel to each other via alleys 130. The rack plates 100 in turn are divided in a plurality of rack shelves 110 in which storing units 120 with goods 10 can be stored, wherein the storing units 120 may have different dimensions.

In accordance with FIG. 2, all rack shelves 110 are dimensioned such that three of the storing units 120 can be arranged in one rack shelf 110. It is also conceivable that a storage area 1 consists of different rack plates 100, that the rack shelves 110 have different sizes, so that the storing and providing of different storing units is also possible.

In accordance with the invention, it is therefore also possible to design and dimension the floor-bound transport systems or the store feeding systems working floor-free, respectively, also differently corresponding to the dimension of the storing units, so that even with the assembly or the commissioning of complex products, such as motor vehicles or household appliances, voluminous goods 10 ate stored in appropriate storing units 120 and goods 10 of smaller dimension in appropriate sections of the storage area 1 which are correspondingly adapted to the dimension of these articles.

The DTS 2 take out, pursuant to order, a storing unit 120 and transport same to a first area 50 at optimal time and path so as to provide the storing unit 120 there. This providing station may, for instance, be designed as commissioning place, in a rack shelf, as supply and removal area of a manufacturing spot, as intermediate buffer, as store, or as a combination of the afore-mentioned variants.

In accordance with FIG. 2, the first area 50 is designed as an intermediate buffer for placing fill pallets into storage, as an automatic empty pallet stacker 52, as stationary commissioning places 54, or as place of removal for fill pallets 51. As is illustrated in FIG. 2, the track network of the DTS 2 is formed such that each DTS 2 can be moved to all first areas 50, wherein it may be useful for optimization to provide parallel paths when these are, for instance, subjected to a high utilization, as it may in particular be the case in the direct vicinity of the stationary commissioning places 54.

By means of the operating unit 4 that is designed as system control, all state data of the DTS 2 are, for instance, known and are coordinated and/or controlled thereof. Expediently, the operating unit 4 that is designed as system control is operatively connected with further systems, e.g. systems for store disposition, bookkeeping, revision, or for assembly automation.

Corresponding to the respective project demands, the DTS 2 transports a storing unit 120, for instance, to a stationary commissioning place 54 at which acts may be performed by means of a conveying means so as to subject the good 10 available on the storing unit 120 to further measures. Such a measure may, for example, consist in the composition of more complex systems, e.g. the composition of mail-order articles or the like, so that the DTS 2 transports the storing unit 120 e.g. back to a rack shelf after the good 10 contained therein has been taken out. Corresponding to the respective categorization of the good 10 that has been taken out, the choice of the respective rack shelf is made.

To enable a providing that is as optimal as possible with respect to time and path, it may, for instance, be possible to arrange the goods that are declared as A-articles as close to the stationary commissioning places 54 as possible. In the case of C-articles it may, however, be useful to store them in rack shelves 110 that are further remote from the stationary commissioning places 54. It may also be useful to perform a chaotic storing strategy to achieve a regular efficiency of the system components.

If, for instance, the last good 10 of a storing unit 120 is taken out at one of the stationary commissioning places 54, the DTS 2 will transmit the empty pallet e.g. to the automatic empty pallet stacker 52.

If, for instance, a good 10 is no longer desired for future orders, or if a complete storing unit 120 is requested, the DTS 2 will transmit the corresponding storing units 120 to the first area 50 that is designed as place of removal for full pallets 51.

FIG. 3 shows the cooperation of the DTS 2 and the TransFaster® 3 in the rack alleys 130. While the TransFaster® 3 is designed to be able to reach all rack levels in an alley 130, the DTS 2 is merely capable of placing in storage, removing from storage, or transferring storing units 120 in one of the lower rack levels. In accordance with FIG. 3, a DTS 2 transports a storing unit 120 to a stationary commissioning place 54 and will transmit the entire storing unit 120 there.

FIG. 4 shows a detailed view of the representation of FIG. 3, wherein the concept for time and path optimization according to the invention can be seen. The DTS 2 is merely capable of attending to the lowermost rack level, so that the storing units with the goods 10.1, 10.5, 10.6, and 10.11 can be directly placed in storage, removed from storage, or transferred by a DTS 2. In order that the DTS 2 can remove the good 10.2 from storage, this good has to be transferred by a TransFaster® in accordance with the Arrow 20 from the instant rack level to the lowermost tack level.

For the placing in storage, removing from storage and transferring, the DTS 2 comprises devices that permit a horizontal movement, for instance, of the storing unit with the good 10.5. The storing units with B- and C-articles, the goods 10.2, 10.3, 10.4, 10.7, 10.10, and 10.9, that are arranged in the higher rack levels that cannot be reached by a DTS 2 have to be transferred corresponding to the system control by a TransFaster® 3 to corresponding tack shelves 110 in the lowermost rack level that can be reached by a DTS 2. In accordance with FIG. 4, this is illustrated by the Arrow 21 that symbolizes a transfer of the good 10.9 to the lowermost rack level.

The movement of a TransFaster® 3 when placing in storage, removing from storage or transferring is illustrated by means of the good 10.8 that is arranged on a load receiving means 31.

FIG. 5 shows a schematic cross-section through a rack alley 130. Furthermore, FIG. 5 shows a rack plate 100 and its subdivision into rack shelves 110, as well as the arrangement of the storing units 120 on which respective goods 10 are positioned. For illustrating the action radius of a TransFaster® 3 with traversing device 32 and load receiving means 31, this is also illustrated in FIG. 5, wherein the arrow indications reflect some possible transport directions.

FIG. 6 shows a schematic top and lateral view of a DTS 2 in a rack alley 130, as well as the required track network 25 that is suited to guide every DTS 2 floor-bound through the storage area 1.

A further component of the inventive system is the performing of an inventive method. In the following, a preferred method variant is explained in more detail by reference to FIG. 4.

If, for instance, the good 10.8 is ordered via the operating unit 4 that is designed as system control, preferably comprising a store administration and operating control system, so as to be transported to a stationary commissioning place 54, the closest TransFaster® 3 is activated to transfer the good 10.8 that is positioned in the third rack level to another rack level to be taken up by a DTS 2 there, which subsequently travels to the corresponding stationary commissioning place 54.

Since there may occur potential collisions between a load receiving means 31 and a DTS 2 during such a transfer within an alley, the movements of the traversing devices 32 and the load receiving means 31 are coordinated and sometimes also controlled via the operating unit 4. In order to be able to guarantee a reliable position detection of the respective vehicles and TransFasters®, as well as of the load receiving means 31 hanging thereon, it may, for instance, be advantageous to provide different sensor levels in the storage area 1, which may be used both cumulatively and alternatively together. A possible position detection may, for example, be performed by opto-electronic measures or path measurement systems.

1. A system for the dynamic providing of storing units with goods contained therein, said system comprising of:
a storage area consisting of at least one rack module composed of at least two rack plates separated from each other by an alley, for storing the storing units in rack shelves;
a floor-bound transport system with at least one vehicle that is designed and suited to take storing units out of said rack shelves and to transport same to at least one providing station inside or outside said storage area;
a store feeding system working floor-free and comprising at least one storing device that is designed and suited to take storing units with goods out of said rack shelves and to transport same above at least one driving track of said vehicle(s) in hanging to at least one commissioning shelf for said floor-bound transport system;
a control system that is designed such that it collects at least the occupancy data of the storing places and the movement and/or position data of said floor-bound vehicles and of said floor-free storing devices and that, by using this information, coordinates and controls the substantial functions of placing in storage and/or returning to storage, storing and/or intermediately buffering, removing from storage and/or providing of the entire system.

2. The system according to claim 1, wherein at least one of said floor-bound transport system and said floor-free store feeding system is designed and suited to transport storing units of said rack shelves from at least one providing station or one commissioning shelf inside or outside said storage area back again.

3. A system for the providing of storing units with goods contained therein, said system comprising of:
a storage area with rack plates separated from one another by at least one alley, comprising rack shelves for storing the storing units in the rack shelves;
a floor-bound transport system with at least one vehicle that is designed and suited to take storing units out of said rack shelves and to transport same through the at least one alley to at least one first area inside or outside said storage area;
a store feeding system working floor-free with at least one traversing unit with load receiving means which is designed and suited to take storing units with goods out of said rack shelves and to transport same above a driving track of said at least one vehicle in hanging to a second area;
at least one operating unit that is designed to collect at least substantial state data of said at least one vehicle and said at least one traversing unit with load receiving means, so that collisions of said at least one vehicle and said at least one traversing unit with load receiving means are avoided.

4. The system according to claim 3, wherein said at least one vehicle is a driverless transport vehicle.

5. The system according to claim 4, wherein said at least one driverless transport vehicle is designed to transport at least one storing unit.

6. The system according to claim 5, wherein the transport units are driverless transport vehicles or trains of barges for one or a plurality of storing units.

7. The system according to claim 3, wherein said at least one driverless transport vehicle comprises lifting means for lifting and lowering said storing units.

8. The system according to claims 3, wherein said traversing unit with load receiving means is positioned in said at least one alley.

9. The system according to claim 8, wherein said traversing unit is designed to be movable on rail-like guiding means.

10. The system according to claim 9, wherein said load receiving means is connected with said traversing means via connecting means.

11. The system according to claim 9, wherein said load receiving means is designed such that storing units are positioned thereon in standing.

12. The system according to claim 10, wherein said load receiving means is designed such that storing units are positioned therebelow in hanging.

13. The system according to claim 3, wherein said first area inside said storage area is a providing station that is formed in a rack shelf.

14. The system according to claim 3, wherein said first area outside said storage area is a providing station that is formed as commissioning place.

15. The system according to claim 3, wherein said first area outside said storage area is a providing station that is formed as supply and removal area of a manufacturing spot.

16. The system according to claim 3, wherein said first area outside said storage area is a providing station that is suited as intermediate buffer.

17. The system according to claim 3, wherein said first area outside said storage area is a providing station that is suited as store.

18. The system according to claim 3, wherein said second area inside said storage area is a providing station that is formed in a rack shelf and is suited as commissioning place.

19. The system according to claim 3, wherein said second area inside said storage area is a providing station that is formed in a rack shelf and is suited as supply and removal area of a manufacturing spot.

20. The system according to claim 3, wherein said second area inside said storage area is a providing station that is formed in a rack shelf and is suited as intermediate buffer.

21. The system according to claim 3, wherein said second area inside said storage area is a providing station that is formed in a rack shelf and is suited as store.

22. The system according to claim 3, wherein at least the respective movement and position data of said at least one vehicle and said at least one traversing unit with load receiving unit are suited as state data.
